(19) United States
(12) Patent Application Publication
(10) Pub. No.: US 2008/0222328 A1
(43) Pub. Date: Sep. 11, 2008

(54) Semiconductor memory module and memory system, and method of communicating therein

(75) Inventors: Jung Hwan Choi, Suwon-si (KR); Young Soo Sohn, Gunpo-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD

(21) Appl. No.: 12/007,205

(22) Filed: Jan. 8, 2008

(30) Foreign Application Priority Data
Mar. 7, 2007 (KR) 10-2007-0022551

(51) Int. Cl. G06F 13/00

(52) U.S. Cl. 710/100

(57) ABSTRACT

Example embodiments relate to a semiconductor memory module and memory system, and a method of communicating therein. According to an example embodiment, a semiconductor memory system may include a memory controller, M interconnected memory elements, and/or N data buses, where N is a natural number and M is a divisor of N. The N data buses may connect the M memory elements to the memory controller. Each memory element may use N/M of the N number of data buses.

### PRIORITY STATEMENT

This application claims priority under 35 U.S.C. § 119 to Korean Patent Application No. 2007-0022551, filed on Mar. 7, 2007, in the Korean Intellectual Property Office, the entire contents of which are incorporated herein by reference.

### BACKGROUND

For double data rate (DDR) 2 or DDR3 memories used in two or more memory slots, a multi-drop method to connect an existing memory module and a memory controller may be adopted. However, a large capacity of load may be applied to a data bus which may make high speed communication more difficult.

Also, next generation memory modules, for example, next generation DRAM, may apply a load of a single memory module to a data bus. However, for a user to increase memory capacity, instead of the conventional memory module, a memory module of a larger capacity may be required. Thus, the extension of memory capacity of a memory module may be difficult.

Some next generation DRAM may be equipped with a repeater in the middle in form of a daisy chain to make high speed communication more practical in a point-to-point method. However, a delay in passing the repeater may exist and further complicate the system.

### SUMMARY

Example embodiments relate to a semiconductor memory module and memory system, and a method of communicating therein. According to an example embodiment, a semiconductor memory system may include a memory controller, M interconnected memory elements, and/or N data buses, where N is a natural number and M is a divisor of N. The N data buses may connect the M memory elements to the memory controller. Each memory element may use N/M of the N number of data buses.

The memory elements may be memory slots, for example, including a first memory slot and a second memory slot. The first memory slot may be connected to the memory controller via N/M first data buses, and the second memory slot may be connected to the memory controller via N/M second data buses. The first memory slot and the second memory slot may also be connected to each other via N/M third data buses.

Alternatively, the memory elements may include first and second memory modules. The first memory module may include N/M first data I/O pins and N/M second data I/O pins different from the first data I/O pins. In this configuration, the memory system may further include a connector. The connector may be configured to connect the first memory module and the second memory module. The first data I/O pins may be used for data input and output between the first memory module and the memory controller. The second data I/O pins may be used for data input and output between the second memory module and the memory controller via the connector. The second memory module may be connected to the top of the first memory module, for example.

According to another example embodiment, a memory module may be connected to a memory controller via N data buses, where N is a natural number, and may include N/M first and second data I/O pins, where M is a divisor of N. The N/M first data I/O pins may be used for data input and output between the memory module and the memory controller. The N/M second data I/O pins may be used for data input and output between an upper memory module positioned above the memory module and the memory controller via a connector.

According to another example embodiment, a method of communicating between memory elements in a semiconductor memory system may include transferring data between a memory controller and M interconnected memory elements using N data buses, where N is a natural number and M is a divisor of N. Each memory element may receive or send data using N/M of the N data buses.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates a memory module and a connection module in a semiconductor memory system according to an example embodiment.

FIG. 2 illustrates two memory modules in a semiconductor memory system according to an example embodiment.

FIG. 3 illustrates a memory module and a connection module in a semiconductor memory system according to another example embodiment.

FIG. 4 illustrates two memory modules in a semiconductor memory system according to another example embodiment.

FIG. 5 illustrates one memory module in a semiconductor memory system according to another example embodiment.

FIG. 6 illustrates two memory modules in a semiconductor memory system according to another example embodiment.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

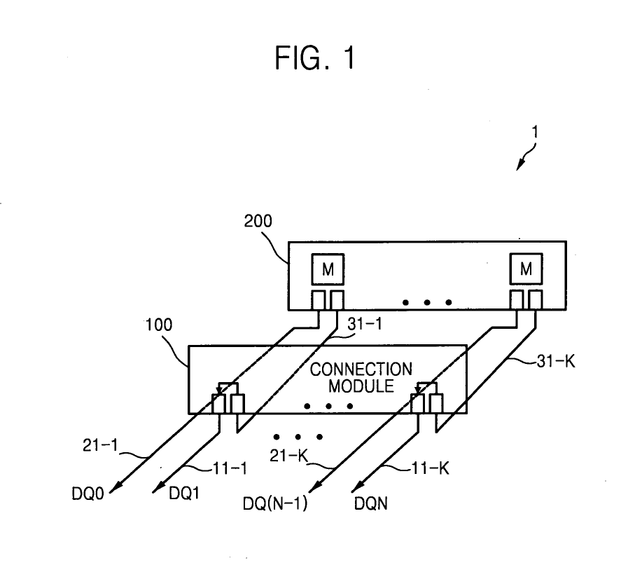

FIG. 1 illustrates a memory module and a connection module in a semiconductor memory system according to an example embodiment. Referring to FIG. 1, a semiconductor memory system 1 may include a memory controller (not shown), N number of data buses (corresponding to DQ1-DQN), where N is a natural number, and M number of memory slots (not shown), where M is a divisor of N. At least one memory module 200 or at least one connection module 100 may be installed at the memory slots.

According to FIG. 1, the semiconductor memory system may include two memory slots (not shown), and the memory module 200 and the connection module 100 may be positioned in each of the memory slots. However, the number of memory slots and modules is not limited to two.

The memory controller may control the flow of data between a host (not shown) and the memory modules. The data controller may selectively control data output by the host to some or all of the memory modules, and data received by the host from some or all of the memory modules. The memory controller may include N number of data I/O pins DQ1-DQN. Each of the N number of data buses may be connected to a corresponding one of the data I/O pins DQ1-DQN.

A first memory slot of the N number of memory slots corresponding to the connection module 100 may be connected to the memory controller via N/M number of first data buses 11-1 through 11-K. Here, K may be N/M. For example, when M is 2 and N is 64, the connection module 100 installed in the first memory slot corresponding to the connection module 100 may be connected to the memory controller via 64/2, that is, 32, first data buses 11-1 through 11-32.

A second memory slot of the M number of memory slots corresponding to the memory module 200 may be connected to the memory controller via N/M number of second data buses 21-1 through 21-K. For example, when M is 2 and N is 64, the memory module 200 installed in the second memory slot corresponding to the memory module 200 may be connected to the memory controller via 64/2, that is, 32, second data buses 21-1 through 21-32.

Also, the first memory slot corresponding to the connection module 100 and the second memory slot corresponding to the memory module 200 may be connected via N/M number of third data buses 31-1 through 31-K.

In FIG. 1, the connection module 100 may be installed between the memory controller and the memory module 200. Thus, the connection module 100 may be located closer to the memory controller than the memory module 200. In this case, the memory module 200 installed in the second memory slot corresponding to the memory module 200 may communicate data with the memory controller via the second data buses 21-1 through 21-K.

Also, the connection module 100 installed in the first memory module corresponding to the connection module 100 may pass data output from the memory module 200 via the third data buses 31-1 through 31-K to the memory controller via the first data buses 11-1 through 11-K. Thus, the connection module 100 may output data input to it as is.

As shown in FIG. 1, when only one memory module 200 is used in the semiconductor memory system 1 having two memory slots, the memory module 200 may be connected to the memory controller via the N/2 number of data buses 21-1 through 21-K. Also, the memory module 200 may be connected to the memory controller via the connection module 100 and the other N/2 number of data buses 11-1 through 11-K. Thus, the memory module 200 and the memory controller may perform a point-to-point communication with relatively little or no loss of bandwidth.

Also, two neighboring data buses of the N number of data buses corresponding to the DQ1-DQN may be data buses connected to different memory modules. For example, as shown in FIG. 1, the two neighboring data buses 21-1 and 11-1 may respectively belong to the second data buses 21-1 through 21-K and the first data buses 11-1 through 11-K. Thus, any consecutive data buses may be connected to different memory slots.

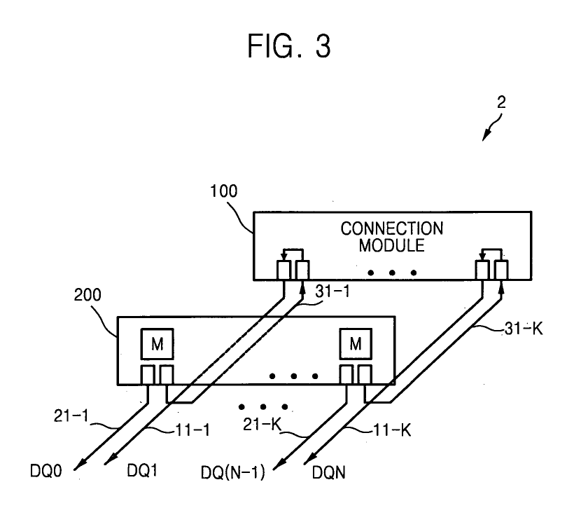

FIG. 3 illustrates a memory module and a connection module in a semiconductor memory system according to another example embodiment. As shown in FIG. 3, the memory module 200 may also be installed between the memory controller and the connection module 100.

Referring to FIGS. 1 and 3, a semiconductor memory system 2 shown in FIG. 3 may have a structure similar to that of the semiconductor memory system 1 shown in FIG. 1, except that the positions of the first memory and the second memory may be switched. Thus, the first memory slot corresponding to the connection module 100 of the M number of memory slots may be connected to the memory controller via the N/M number of first data buses 11-1 through 11-K. Also, the second memory slot corresponding to the memory module 200 of the M number of memory slots may be connected to the memory controller via the N/M number of second data buses 21-1 through 21-K.

The first memory slot and the second memory slot may be connected to each other via the N/M number of third data buses 31-1 through 31-K. The connection module 100 installed in the first memory slot may pass data output from the memory module 200 via the third data buses 31-1 through 31-K to the memory controller via the first data buses 11-1 through 11-K.

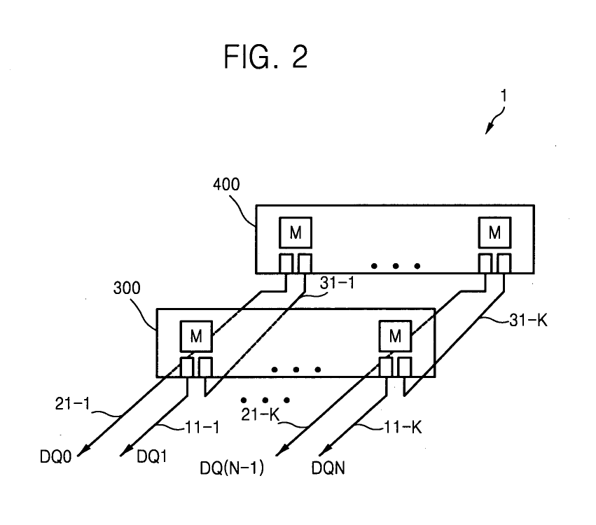

FIG. 2 illustrates two memory modules in a semiconductor memory system according to an example embodiment. FIG. 2 shows an example configuration in which two memory modules may be installed in the semiconductor memory system 1 shown in FIG. 1. Referring to FIG. 2, the semiconductor memory system 1 may include a first memory module 300 and a second memory module 400.

The first memory module 300 may be installed in the first memory slot and may communicate data with the memory controller via the first data buses 11-1 through 11-K. Also, the second memory module 400 may be installed in the second memory slot and may communicate data with the memory controller via the second data buses 21-1-21-K.

For example, when M is 2, each of the first and second memory modules 300 and 400 may be connected to the memory controller via N/2 number of data buses. Each of the first and second memory modules 300 and 400 may disable data I/O pins connected to the third data buses 31-1 through 31-K. Because only N/2 of the N number of data I/O pins included in each of the first and second memory modules 300 and 400 are connected to the memory controller, each of the first and second memory modules 300 and 400 may disable the remaining N/2 number of data I/O pins that are not connected to the memory controller. Data may not be transferred via the third data buses 31-1 through 31-K. In this configuration, the first and second memory modules 300 and 400 may communicate with the memory controller in a point-to-point method respectively via the N/2 number of data buses 11-1 through 11-K and 21-1 through 21-K.

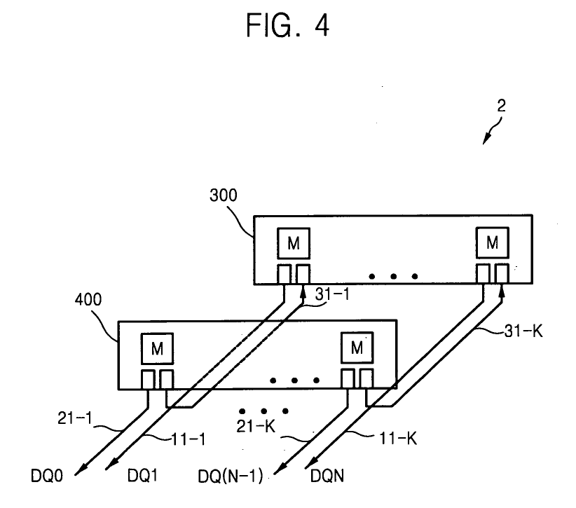

FIG. 4 illustrates two memory modules in a semiconductor memory system according to another example embodiment. FIG. 4 illustrates an example configuration in which two memory modules are installed in the semiconductor memory system 2 of FIG. 3.

Comparing FIG. 4 and FIG. 2, a semiconductor memory system 2 shown in FIG. 4 may have a structure and operation similar to those of the semiconductor memory system 1 shown in FIG. 2, except that the positions of the first memory slot corresponding to the memory module 300 and the second memory slot corresponding to the memory module 400 may be switched. The first memory module 300 may be installed in the first memory slot and communicate data with the memory controller via the first data buses 11-1 through 11-K. Also, the second memory module 400 may be installed in the second memory slot and communicate data with the memory controller via the second data buses 21-1 through 21-K.

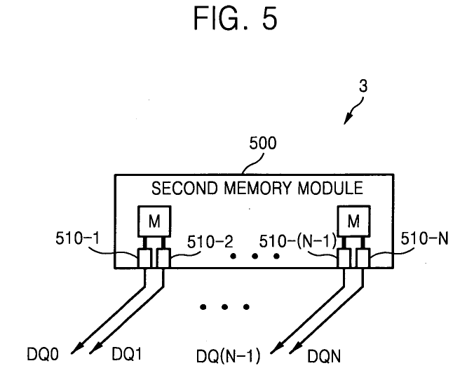

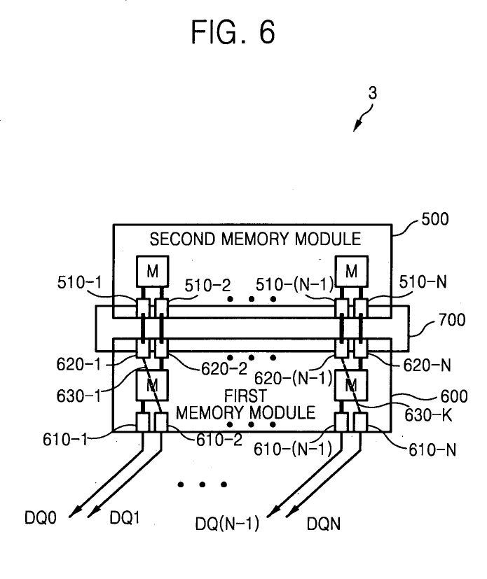

FIG. 5 illustrates one memory module in a semiconductor memory system according to another example embodiment. FIG. 6 illustrates two memory modules in a semiconductor memory system according to another example embodiment.

Referring to FIGS. 5 and 6, when only the second memory module 500, for example, a DRAM memory module, is used, a semiconductor memory system 3 may have a structure that is the same as or similar to that of a conventional semiconductor memory system. As shown in FIG. 5, when the second memory module 500 is installed in a memory slot corresponding to the second memory module 500, the semiconductor memory system 3 may have a structure that is the same as or similar to a conventional semiconductor memory system having only one memory slot.

Thus, the semiconductor memory system 3 according to an example embodiment may be compatible with conventional semiconductor memory systems. As shown in FIG. 6, when two or more memory modules are used, a semiconductor memory system according to an example embodiment may be obtained by modifying a conventional semiconductor memory system by upgrading or replacing the memory controller and adding additional constituent elements.

Thus, the second memory module 500 may include N number of data I/O pins 510-1 through 510-N respectively connected to the N number of data buses corresponding to the DQ1-DQN, where N is again a natural number. The second memory module 500 may communicate data with the memory controller via the data I/O pins 510-1 through 510-N.

A semiconductor memory system according to an example embodiment with two or more memory modules is shown in FIG. 6. Referring to FIG. 6, the semiconductor memory system 3 may include a memory controller (not shown), N number of data buses corresponding to the DQ1-DQN, where the N is again a natural number, a first memory module 600, a second memory module 500, and a connector 700.

The first memory module 600 may be connected to the data buses corresponding to the DQ1-DQN. The second memory module 500 may be installed above the first memory module 600 as shown in FIG. 6, where the connector 700 may connect the first memory module 600 and the second memory module 500.

The first memory module 600 may include N/M number of first data I/O pins 610-1 through 610-(X−1), where the M is a divisor of N, and X is an even number greater than 1 and less than or equal to N. The first data I/O pins 610-1 through 610-(X−1) may be used for data input and output between the first memory module 600 and the memory controller. The first memory module 600 may also include N/M number of second data I/O pins 610-2 through 610-X installed above the first memory, which may be used for data input and output between the second memory module 500 and the memory controller. For example, the first data I/O pins 610-1 through 610-(X−1) may correspond to the odd numbered I/O pins 610-1, 610-3, etc., and the second data I/O pins 610-2 through 610-X may correspond to the even numbered I/O pins 610-2, 610-4, etc.

Also, the first memory module 600 may further include N/M number of inner data buses 630-1 through 630-K, where the K is N/M, connected to the connector 700 and the second data I/O pins 610-2 through 610-X. The first memory module 600 may further include N number of connection pins 620-1 through 620-N to connect the connector 700 and the first memory 600.

The first data I/O pins 610-1 through 610-(X−1) may be used for data input and output between the first memory module 600 and the memory controller. The first data I/O pins 610-1 through 610-(X−1) and the N/M number of second data I/O pins 610-2 through 610-X different from each other may be used for data input and output between the second memory module 500 and the memory controller via the connector 700.

For example, with reference to FIG. 6, when M is 2, the data stored in at least one memory bank included in the first memory module 600 may be input/output with respect to the memory controller via the first data I/O pins 610-1 through 610-(X−1) and the data buses DQ1-DQ(X−1) corresponding to each of the first data I/O pins 610-1-610-(X−1).

Also, the data stored in at least one memory bank included in the second memory module 500 may be output to the data pins 510-1 through 510-(X−1) connected to the inner data buses 630-1 through 630-K of the data pins 510-1 through 510-(X−1) included in the second memory module 500 via the connector 700. The data may be transferred to the connection pins 620-1 through 620-(X−1) connected to the inner data buses 630-1-630-K via the connector 700.

The data may be transferred to the second data I/O pins 610-2 through 610-X via the inner data buses 630-1 through 630-K. The transferred data may be output to the memory controller via the data buses corresponding to each of the second data I/O pins 610-2-610-X which may correspond to each of the DQ1-DQX.

Also, the second memory module 500 may disable the data pins 510-2 through 510-X of the data pins 510-1 through 510-N included in the second memory module 500, which may not be connected to the inner data buses 630-1 through 630-K, via the connector 700. The connector 700 may connect each of the data pins 510-1 through 510-N included in the second memory module 500 and the connection pins 620-1 through 620-(X−1) corresponding to each of the data pins 510-1-510-N included in the second memory module 500.

Thus, the semiconductor memory system 3 of FIG. 6 may use a conventional memory module, for example, a DRAM memory module, as it is, for the second memory module 500. Also, a communication in a point-to-point method may be achieved without having a plurality of memory slots in the semiconductor memory system 3.

As described in the above, the semiconductor memory system and memory module according to example embodiments may extend memory capacity and have relatively little or no loss of bandwidth in performing a point-to-point communication.

In addition, example embodiments are directed to a method of communicating between memory elements in a semiconductor memory system, as previously described with reference to FIGS. 1-6. For example, the method may include transferring data between a memory controller and M interconnected memory elements using N data buses. Accordingly, each memory element may receive or send data using N/M of the N data buses.

For a configuration where the memory elements include a connection module and a memory module, the method may also include transferring data between the memory module and the memory controller via the connection module. In addition, data may be transferred between the memory module and the connection module using N/M data buses.

For the configuration where the memory elements include first and second memory modules, the method may also include transferring data between the second memory module and the memory controller via inner data buses of the first memory module.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A semiconductor memory system, comprising:
a memory controller;
M interconnected memory elements; and
N data buses connecting the M memory elements to the memory controller, each memory element using N/M of the N number of data buses, where N is a natural number and M is a divisor of N.

2. The semiconductor memory system of claim 1, wherein the memory elements are memory slots, including a first memory slot connected to the memory controller via N/M first data buses and a second memory slot connected to the memory controller via N/M second data buses, and
the first memory slot and the second memory slot are connected to each other via N/M third data buses.

3. The semiconductor memory system of claim 2, further comprising:
a memory module in the second memory slot configured to communicate data with the memory controller via the second data buses; and
a connection module in the first memory slot configured to bypass data output from the memory module via the third data buses and output the data to the memory controller via the first data buses.

4. The semiconductor memory system of claim 3, wherein the connection module is positioned between the memory controller and the memory module.

5. The semiconductor memory system of claim 3, wherein the memory module is positioned between the memory controller and the connection module.

6. The semiconductor memory system of claim 2, further comprising:
a first memory module in the first memory slot configured to communicate data with the memory controller via the first data buses; and
a second memory module in the second memory slot configured to communicate data with the memory controller via the second data buses.

7. The semiconductor memory system of claim 6, wherein each of the first memory module and the second memory module disables data I/O pins connected to the third data buses.

8. The semiconductor memory system of claim 2, wherein two neighboring data buses of the N data buses are connected to different memory modules.

9. The semiconductor memory system of claim 1, wherein the memory elements include first and second memory modules, the first memory module including N/M first data I/O pins and N/M second data I/O pins different from the first data I/O pins, the memory system further comprising:
a connector configured to connect the first memory module and the second memory module, wherein
the first data I/O pins are used for data input and output between the first memory module and the memory controller, and the second data I/O pins are used for data input and output between the second memory module and the memory controller via the connector.

10. The semiconductor memory system of claim 9, wherein the second memory module is connected to the top of the first memory module.

11. The semiconductor memory system of claim 9, wherein the first memory module includes N/M inner data buses connected to the second data I/O pins and the connector.

12. The semiconductor memory system of claim 11, wherein the second memory module disables data pins included in the second memory module that are not connected to the inner data buses via the connector.

13. The semiconductor memory system of claim 11, wherein the first memory module further includes N connection pins configured to connect the connector and the first memory module.

14. A memory module connected to a memory controller via N data buses, where N is a natural number, the memory module comprising:
N/M first data I/O pins, where M is a divisor of N, used for data input and output between the memory module and the memory controller; and
second data I/O pins used for data input and output between an upper memory module positioned above the memory module and the memory controller via a connector.

15. The memory module of claim 14, further comprising:
N/M number of inner data buses connected to the second data I/O pins and the connector.

16. The memory module of claim 14, further comprising:
N connection pins configured to connect the connector and the memory module.

17. A method of communicating between memory elements in a semiconductor memory system, the method comprising:
transferring data between a memory controller and M interconnected memory elements using N data buses, each memory element receiving or sending data using N/M of the N data buses, where N is a natural number and M is a divisor of N.

18. The method of claim 17, wherein the memory elements include a connection module and a memory module, the method further comprising:
transferring data between the memory module and the memory controller via the connection module.

19. The method of claim 18, further comprising:
transferring data between the memory module and the connection module using N/M data buses.

20. The method of claim 17, wherein the memory elements include first and second memory modules, the method further comprising:
transferring data between the second memory module and the memory controller via inner data buses of the first memory module.
